(19) United States
(12) Patent Application Publication
(10) Pub. No.: US 2025/0026929 A1
(43) Pub. Date: Jan. 23, 2025

(54) POLYCARBONATE COMPOSITION

(71) Applicant: SABIC GLOBAL TECHNOLOGIES B.V., Bergen op Zoom (NL)

(72) Inventors: Sijun Li, Shanghai (CN); Dave Wang, Geleen (NL)

(21) Appl. No.: 18/716,723

(22) PCT Filed: Dec. 2, 2022
(86) PCT No.: PCT/EP2022/084156

§ 371 Date: Jun. 5, 2024

(30) Foreign Application Priority Data
Dec. 6, 2021 (WO) PCT/CN2021/135649
Jan. 18, 2022 (EP) 22152059.6

(51) Int. Cl. C08L 69/00; C08K 5/42

(52) U.S. Cl. CPC C08L 69/00; C08K 5/42; C08L 2205/025; C08L 2205/03

(57) ABSTRACT

Disclosed herein is a thermoplastic composition comprising, based on the total weight of the composition (A) from 85-97 wt. % of aromatic polycarbonate, (B) from 3-12 wt. % of a core-shell impact modifier wherein the core is comprised of silicone and the shell comprised of acrylate, (C) from 0.01-1.5 wt. % of a flame retardant, (D) from 0.01-2 wt. % of anti-drip agent, wherein the sum of components (A)-(D) is at least 95 wt. % of the total weight of the composition, and wherein the composition is selected to have a melt volume rate of from 5-20 cm³/10 min. measured in accordance with ISO 1133 (300° C., 1.2 kg), and a UL flame retardancy rating of V0 at 1.2 mm, and a notched Izod Impact strength of at least 35 kJ/m² at a temperature of −50° C. measured in accordance with ISO 180/A on injection moulded test bars of 80×10×3 mm.

### CROSS REFERENCE TO RELATED APPLICATIONS

This application is a National Stage application of PCT/EP2022/084156, filed Dec. 2, 2022, which claims the benefit of PCT/CN2021/135649 filed Dec. 6, 2021, and European Application No. 22152059.6, filed Jan. 18, 2022, all of which are incorporated by reference in their entirety herein.

### BACKGROUND

The present invention relates to a polycarbonate composition having, in combination, good flame retardant properties and low temperature impact properties. Such compositions are in particular useful for applications wherein the material needs to be tough over a wide temperature range. For example these compositions may be used in outdoor electronic applications such as housing or enclosure for or components of charging stations for electrical vehicles. In addition these compositions may be useful for components or housing used for mobile communication systems such as equipment used for 3G, 4G or 5G communication equipment (Antenna, Radome etc.). Alternatively any outdoor appliances such as for example housing or components of power tools or other (portable) electronic devices, such as portable bar or QR code scanners for supermarkets or in the logistics industry, may benefit from the present invention.

US 2019/0185664 discloses a thermoplastic composition comprising from about 49.5 wt. % to about 97.95 wt. % of at least one polycarbonate polymer based on the total weight of the thermoplastic composition; from about 2.0 wt. % to about 49.5 wt. % of at least one polycarbonate-siloxane copolymer, based on the total weight of the thermoplastic composition wherein a total siloxane content of the thermoplastic composition is about 1.0 wt. % to about 5.0 wt. % based on the total weight of the thermoplastic composition; and from about 0.05 wt. % to about 1.0 wt. % of at least one mold release agent, based on the total weight of the thermoplastic composition, wherein the thermoplastic composition exhibits a melt volume flow rate of at least about 25 cm³/10 min, as determined according to ISO 1133 at 300° C. using a 1.2 kg load; a ductile/brittle transition temperature of less than or equal to 10° C., as determined in accordance with ISO 180-1A on a molded part having a thickness of 3 mm; and an L* that is less than about 30% higher compared to a reference thermoplastic composition without the polycarbonate-siloxane copolymer, as measured according to ASTM D1729 on a 3 mm thick metallized plaque in reflectance and specular excluded mode.

US 2014/0329920 discloses a composition comprising a polycarbonate-siloxane copolymer; a silicone-based graft copolymer comprising (a) 60% to 80% by weight of a silicone core component, and (b) a graft polymer shell derived from at least methacrylic ester monomer, and an anti-drip agent; wherein a flame bar comprising the composition achieves a UL94 V0 rating at a thickness of 1.2 mm or 1.0 mm; wherein the composition has a notched Izod impact strength (NII) of greater than or equal to 500 J/m, measured at −40° C. according to ASTM D256; and wherein the composition does not include aliphatic poly ester-polycarbonate copolymers.

### SUMMARY

It is an object of the invention to provide for a thermoplastic composition which can be manufactured in a cost-effective manner and which combines reasonable flow, good thin-wall flame retardancy and good low temperature impact properties.

This object is met in accordance with the invention disclosed herein which is directed at a thermoplastic composition comprising, based on the total weight of the composition
(A) from 85-97 wt. % of aromatic polycarbonate
(B) from 3-12 wt. % of a core-shell impact modifier wherein the core is comprised of silicone and the shell comprised of acrylate,
(C) from 0.01-1 wt. % of a flame retardant
(D) from 0.01-2 wt. % of anti-drip agent,
wherein the sum of components (A)-(D) is at least 95 wt. % of the total weight of the composition, and wherein the composition is selected to have
a melt volume rate of from 5-20 cm³/10 min. measured in accordance with ISO 1133 (300° C., 1.2 kg), and
a UL flame retardancy rating of V0 at 1.2 mm, and
a notched Izod Impact strength of at least 35 kJ/m² at a temperature of −50° C. measured in accordance with ISO 180/A on injection moulded test bars of 80×10×3 mm.

### DETAILED DESCRIPTION

The present inventors in particular found that, compared to some compositions disclosed in the prior art, the use of expensive polycarbonate-polysiloxane copolymers can be avoided if use is made of core shell impact modifiers comprising a core based on silicone rubber, in particular but not per se limited to those core shell impact modifiers having a high silicone content. Such impact modifiers were found to provide sufficient low temperature impact properties. Further to that the present inventors found that when combined with one or more of a flame retardant thin wall flame retardancy can be successfully achieved.

### Polycarbonate

Aromatic polycarbonates are generally manufactured using two different technologies. In a first technology, known as the interfacial technology or interfacial process, phosgene is reacted with a bisphenol, typically bisphenol A (BPA) in a liquid phase. Another well-known technology is the so-called melt technology, sometimes also referred to as melt transesterification or melt polycondensation technology. In the melt technology, or melt process, a bisphenol, typically BPA, is reacted with a carbonate, typically diphenyl carbonate (DPC), in the melt phase. Aromatic polycarbonate obtained by the melt transesterification process is known to be structurally different from aromatic polycarbonate obtained by the interfacial process. In that respect it is noted that in particular the so called “melt polycarbonate” typically has a minimum amount of Fries branching, which is generally absent in “interfacial polycarbonate”. Apart from that melt polycarbonate typically has a higher number of phenolic hydroxy end groups while polycarbonate obtained by the interfacial process is typically end-capped and has at most 150 ppm, preferably at most 50 ppm, more preferably at most 10 ppm of phenol hydroxyl end-groups.

In accordance with the invention, it is preferred that the aromatic polycarbonate comprises or consists of bisphenol A polycarbonate homopolymer (also referred to herein as bisphenol A polycarbonate). Preferably, the aromatic polycarbonate of the invention disclosed herein comprises at least 75 wt. %, preferably at least 90 wt. % of bisphenol A polycarbonate based on the total amount of aromatic polycarbonate. More preferably, the aromatic polycarbonate in the composition essentially consists or consists of bisphenol A polycarbonate, essentially consisting meaning that the aromatic polycarbonate comprises at least 98 wt. % of bisphenol A polycarbonate. It is preferred that the aromatic polycarbonate has a weight average molecular weight (Mw) of 15,000 to 60,000 g/mol determined using gel permeation chromatography with polycarbonate standards. Preferably the Mw of the aromatic polycarbonate is from 30,000-65,000 g/mol.

In an aspect, the polycarbonate is an interfacial polycarbonate.

In another aspect, the polycarbonate is a melt polycarbonate, preferably a melt polycarbonate essentially consisting or consisting of bisphenol A polycarbonate. In yet another aspect the polycarbonate is a mixture of from 20-80 wt. % or 40-60 wt. % of interfacial polycarbonate and from 80-20 wt. % or 60-40 wt. % of melt polycarbonate, based on the weight of the aromatic polycarbonate.

The polycarbonate may be a mixture of two or more polycarbonates differing in melt volume rate (i.e. in molecular weight). The polycarbonates of the mixture may both be a bisphenol A polycarbonate homopolymer.

In another aspect the aromatic polycarbonate comprises a polycarbonate copolymer comprising structural units of bisphenol A and structural units from another bisphenol.

The aromatic polycarbonate (A) preferably has a melt volume rate of from 1-30, preferably 5-30 cm³/10 min as determined in accordance with ISO 1133 (300° C., 1.2 kg). The melt volume rate of the polycarbonate (A) may be from 6-26 cm³/10 min. In case the polycarbonate (A) is a mixture of two or more polycarbonates then this requirement applies to the mixture and accordingly does not limit the melt volume rates of the individual polycarbonates. It is however preferred that each individual polycarbonate in such a mixture has a melt volume rate of from 1-30, preferably 5-30 or 6-26 cm³/10 min.

### Impact Modifier

The core-shell impact modifier has a core comprised of silicone and a shell comprised of an acrylate polymer. The core-shell impact modifier, or impact modifier, is a silicone-based core-shell graft copolymer having a structure in which a vinyl monomer is grafted onto a silicone-based rubber core, thereby forming a rigid shell.

The impact modifier preferably comprises at least 25 wt. %, more preferably at least 35 wt. %, more preferably at least 50 wt. % of silicone as the core material. The term silicone means a polymer of a siloxane, i.e. a polysiloxane. The siloxane can be a polyorganosiloxane or a polydiorganosiloxane of general structure—(O—Si—R₃) wherein at least one R is an oxygen atom and at the remaining R groups are organic groups, typically C₁-C₆ organic groups, optionally containing a hetero atom or hydrogen. In the context of the present invention and for the avoidance of doubt it is to be understood that the core of the core-shell impact modifier is a silicone rubber. The graft copolymer shell is preferably derived from mainly methacrylic ester monomer.

The core shell impact modifier is silicone-based core-shell graft copolymer having a structure in which a vinyl monomer is grafted onto a silicone-based rubber core, thus forming a rigid shell. The silicone-based rubber core may be made of cyclosiloxane, examples of which may include hexamethyl-cyclotrisiloxane, octamethyl-cyclotetrasiloxane, decamethyl-cyclopentasiloxane, dodecamethyl-cyclohexasiloxane, trimethyltriphenyl-cyclotrisiloxane, tetramethyltetraphenyl-cyclotetrosiloxane, octaphenyl-cyclotetrasiloxane, and the like, and mixtures thereof. The vinyl monomer comprises or consists of acrylate monomers including for example acrylonitrile, methacrylonitrile, C₁-C₈ methacrylic acid alkylester, C₁-C₈, acrylic acid alkylester. The C₁-C₈ methacrylic acid alkylester and C₁-C₈ acrylic acid alkylester belong to esters of methacrylic acid and acrylic acid, respectively, which are esters derived from monohydric alcohol having 1 to 8 carbon atoms. Particular examples thereof may include methacrylic acid methyl ester, methacrylic acid ethyl ester and methacrylic acid propyl ester.

The rubber content of the silicone-based core-shell graft copolymer can be in the range of from 30-90 wt. % based on the weight of the core-shell graft copolymer. The silicone content of the rubber core can be in the range of 20-100 wt. %, or 20-95 wt. % based on the weight of the rubber core.

The silicone-based rubber core component may be prepared by mixing a siloxane with one or more curing agents. Examples of suitable curing agents may include trimethoxymethylsilane, triethoxyphenylsilane, tetramethoxysilane, tetraethoxysilane, and the like, and mixtures thereof. The silicone-based core-shell graft copolymer may then be prepared by graft polymerization of the acrylate monomer onto the rubber core. Methods for preparing such core-shell impact modifiers are well-known in the art and will be readily understood by a person skilled in the art. The core-shell impact modifiers used in the context of the invention are commercially available for example from Kaneka under the trade name Kane Ace. Example materials of particular suitability in the present invention are Kane Ace MR series of acrylic—silicone polymers. Reference is made at least to one or more of U.S. Pat. No. 7,615,594, EP1500682, US 2019/0185664, US 2014/0329920.

### Flame Retardant

The flame retardant comprised in the composition of the invention is not strictly limited and any type of flame retardant can be used. It is however preferred that the flame retardant is a chlorine and bromine free flame retardant.

The flame retardant may be a chlorine and bromine free salt. More in particular the flame retardant may be a chlorine and bromine free alkali, alkaline earth or ammonium salt, such as alkali metal salts of perfluorinated C₁-C₁₆ alkyl sulfonates such as potassium perfluorobutane sulfonate (KPFS, also known as Rimar salt), potassium perfluoroctane sulfonate, tetraethylammonium perfluorohexane sulfonate, potassium diphenylsulfone sulfonate (KSS), sodium benzene sulfonate, sodium toluene sulfonate (NATS). Further included are salts formed by reacting for example an alkali metal or alkaline earth metal (such as lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AIF₆, BaSiF₆, KBF₆, K₃AIF₆ KAIF₄, K₂SiF₆ and/or Na₃AIF₆ or the like.

It is preferred that the flame retardant is KPFS, KSS, NATS or combinations of at least two thereof.

The amount of flame retardant is from 0.01-1.5 wt. %, preferably from 0.05-1.2 wt. %, more preferably from 0.1-1.0 wt. % based on the weight of the thermoplastic composition. Preferably the amount of flame retardant is at most 0.8 wt. % or 0.5 wt. %.

### Anti-Drip Agent

The thermoplastic composition of the invention comprises from 0.01-2 wt. % of an anti-drip agent. Anti-drip agents are known to the skilled person. The anti-drip agent may be a fibril forming polytetrafluoroethylene (PTFE). The fibril forming polytetrafluoroethylene (PTFE) may be present in the composition in an amount of about 0.1-1.5 wt. %, more preferably from 0.2-0.8 wt. % based on the weight of the composition. The anti-drip agent is preferably a fibril forming polytetrafluoroethylene encapsulated by styrene-acrylonitrile copolymer (TSAN). The TSAN may be present in the composition in an amount of 0.1-1.5 wt. %, preferably from 0.2-0.8 wt. %. TSAN may be preferred for improved dispersion in the polycarbonate matrix. An exemplary TSAN can comprise from 30-70 wt. %, preferably 40-60 wt. % PTFE and 70-30 or 60-40 wt. % SAN, based on the total weight of the encapsulated fluoropolymer.

### Composition

The sum of components (A)-(D) is at least 95 wt. % of the total weight of the composition. Preferably the sum of components (A)-(D) is at least 98 wt. % or at least 99 wt. % based on the weight of the composition. For the avoidance of doubt it is noted that the total weight of the thermoplastic composition equals 100 wt. %.

In an embodiment the thermoplastic composition consists of the components (A)-(D) and a further component (E) in an amount of at most 2 wt. % and selected from the group consisting of colorants, UV stabilisers, mould-release agents, heat stabilisers and anti-oxidants.

It is preferred that the composition does not comprise a polycarbonate-polysiloxane copolymer and/or a polysiloxane.

In accordance with the invention, the composition disclosed herein is selected to have,
a melt volume rate of from 5-20 cm³/10 min. measured in accordance with ISO 1133 (300° C., 1.2 kg), and
a UL flame retardancy rating of V0 at 1.2 mm, and
a notched Izod Impact strength of at least 35 kJ/m² at a temperature of −50° C. measured in accordance with ISO 180/A on injection moulded test bars of 80×10×3 mm.

Preferably the melt volume rate of the composition is from 8-15 cm³/10 min.

Preferably the composition is selected to have a UL flame retardancy rating of V0 at 1.0 mm.

Preferably the composition is selected to have a notched Izod Impact strength of at least 40 kJ/m² or at least 50 kJ/m² at a temperature of −50° C. The upper limit for notched Izod Impact strength is not particularly limited and in the context of the present invention dictated by the combination of materials. A notched Izod Impact strength at −50° C. may be at most 65 kJ/m², preferably at most 62 kJ/m² or at most 60 kJ/m².

Preferably the composition is selected to have a notched Izod Impact strength of at least 70 kJ/m² or at least 72 kJ/m² at a temperature of 23° C. The upper limit for notched Izod Impact strength is not particularly limited and in the context of the present invention dictated by the combination of materials. A notched Izod Impact strength at 23° C. may be at most 85 kJ/m², preferably at most 80 kJ/m² or at most 75 kJ/m².

### Use/Article

The present invention further relates to an article preferably an injection molded article comprising or consisting of the composition disclosed herein. Of particular interest are articles used for outdoor electronic applications such as housings for charging stations for electronic vehicles, mobile communication equipment like 5G antenna stations and radomes; Telecom device (interphone, etc.) and other applications like energy storage enclosures, measuring equipment, sports apparatus and so on.

The present invention is further directed at the use of the composition disclosed herein for the manufacture of such articles.

In a particular aspect the present invention is directed at the use of a core shell impact modifier as defined herein for the manufacture of articles having in combination an increased low temperature impact strength and a UL flame retardancy rating of V0 at 1.2 mm.

The invention as presented herein will now be further elucidated on the basis of the following non-limiting examples.

The present examples and comparative examples together with the description provided herein is considered to provide the skilled person sufficient guidance to manufacture further compositions meeting the required properties. In that respect it is further noted that the invention as presented herein requires a composition which is selected to have certain properties. The properties and their method of determination are well known as such so that accordingly the skilled person is not faced with an undue burden to establish whether or not a further composition meets the requirements of the invention as defined and disclosed herein.

### Measurement Methods

| | |
|---|---|
| Heat Deflection | Heat Deflection Temperature was determined on |
| Temperature | injection moulded test bars having dimensions 127 × |
| (HDT) | 12.7 × 3.2 mm with 1.82 MPa load in accordance with |
| | ASTM D 648. |
| Izod notched | Impact strength was determined on injection moulded |
| Impact Strength | test bars having dimensions 80 × 10 × 3 mm and |
| (NI) | provided with a notch in accordance with ISO 180/A. |
| | The reported value is the average of 5 measurements |
| | wherein the impact strength is expressed in kJ/m². |
| | Measurements were performed at several |
| | temperatures as shown in the tables below. |
| Melt volume | The melt volume rate was determined in accordance |
| rate (MVR) | with ISO 1133 at 300° C. and a load of 1.2 kg |
| Flame retardancy | Flame retardancy tests were carried out in |
| rating | accordance with the UL 94 requirements. The tests |
| (UL rating) | were carried out on injection moulded test specimens |
| | having a length of 127 mm, a width of 12.7 mm and |
| | thicknesses of 1.0 mm, 1.2 mm and 1.5 mm |

### Materials

TABLE 1

| Material | Description |
|---|---|
| PC-1 | Bisphenol A polycarbonate homopolymer obtained via a melt |
| | transesterification process and having a melt flow rate (MFR) of 7 g/ |
| | 10 min, determined in accordance with ISO 1133 (1.2 kg, 300° C.) and |
| | obtained from SABIC |
| PC-2 | Bisphenol A polycarbonate homopolymer obtained via a melt |
| | transesterification process and having a melt flow rate (MFR) of 27 g/ |
| | 10 min, determined in accordance with ISO 1133 (1.2 kg, 300° C.) and |
| | obtained from SABIC |
| PC-3 | Bisphenol A polycarbonate homopolymer obtained via an interfacial |
| | polymerisation process and having a melt flow rate (MFR) of 7 g/10 min, |
| | determined in accordance with ISO 1133 (1.2 kg, 300° C.) and obtained |
| | from SABIC |
| PC-4 | Bisphenol A polycarbonate homopolymer obtained via an interfacial |
| | polymerisation process and having a melt flow rate (MFR) of 7 g/10 min, |
| | determined in accordance with ISO 1133 (1.2 kg, 300° C.) and obtained |
| | from SABIC |
| MBS-1 | Methyl-methacrylate-butadiene-styrene copolymer (MBS) impact |
| | modifier, having a rubber content of about 78 wt. %, commercially |
| | available from Kaneka under the trade name KaneAce M511 |
| MBS-2 | Methyl-methacrylate-butadiene-styrene copolymer (MBS) impact |
| | modifier, having a rubber content of about 71 wt. %, commercially |
| | available from Kaneka under the trade name KaneAce M732 |
| MBS-3 | MBS impact modifier, having a rubber content of about 90 wt. %, |
| | commercially available from DOW under the trade name PARALOID |
| | EXL-2390 |
| MBS-4 | MBS impact modifier with a rubber content of about 75 wt. % |
| | commercially available from Mitsubishi under the trade name Metablen |
| | E-875A |
| MR01 | Silicone based flame retardant core-shell impact modifier having a |
| | silicone core and an acrylic shell wherein the silicone rubber content is |
| | about 80 wt. %; commercially available from Kaneka under the trade |
| | name Kane Ace MR01. |
| MR03 | Silicone based flame retardant core-shell impact modifier having a |
| | silicone core and an acrylic shell wherein the silicone rubber content is |
| | about 80 wt. %; commercially available from Kaneka. MR03 has an |
| | improved hydrostability compared to MR01 |
| S2030 | Silicone based core-shell impact modifier having a silicone core and an |
| | acrylic shell wherein the silicone rubber content is about 30 wt. %; |
| | commercially available from Mitsubishi under the trade name Metablen |
| | S2030. |
| S2130 | Silicone based core-shell impact modifier having a silicone core and an |
| | acrylic shell wherein the silicone rubber content is about 30 wt. %; |
| | commercially available from Mitsubishi under the trade name Metablen |
| | S2130. |
| SX005 | Silicone based flame retardant core-shell impact modifier having a |
| | silicone core and an acrylic shell wherein the silicone rubber content is |
| | about 72 wt. %; commercially available from Mitsubishi under the trade |
| | name Metablen SX005 |
| Rimar | potassium perfluorobutane sulfonate (Rimar salt) commercially available |
| | from Lanxess |
| TSAN | SAN encapsulated PTFE with an amount of 50 wt. % PTFE on the basis |
| | of the encapsulated PTFE |
| KSS | potassium diphenyl sulfone sulfonate, commercially available from |
| | Metropolitan Eximchem Ltd. |
| NATS | sodium toluenesulfonate commercially available from Arichem |
| Additives | Additive package consisting of |
| | 0.06 wt. % Tris(2,4-di-tert-butylphenyl)phosphite (AO 168), |
| | 0.06% Octadecyl β - (3,5-di-tert-butyl-4-hydroxy phenyl)- |
| | propionate (1076) |
| | 0.3% Pentaerythrityl Tetrastearate (PETS) |
| | 0.2% 2-(2 hydroxy-5-t-octylphenyl) benzotriazole (UVA) |
| | (wt. % based on the weight of the composition) |

Table 2 below shows a first series of experiments

TABLE 2

| | | CE1 | CE2 | CE3 | CE4 | CE5 | E1 | E2 | CE6 | CE7 | E3 |
|---|---|---|---|---|---|---|---|---|---|---|---|
| | wt. % | 0.62 | 0.62 | 0.62 | 0.62 | 0.62 | 0.62 | 0.62 | 0.62 | 0.62 | 0.62 |
| PC-1 | wt. % | 68.75 | 62.73 | 62.73 | 62.73 | 62.73 | 62.73 | 62.73 | 62.73 | 62.73 | 62.73 |
| PC-2 | wt. % | 30 | 30 | 30 | 30 | 30 | 30 | 30 | 30 | 30 | 30 |
| TSAN | wt. % | 0.5 | 0.5 | 0.5 | 0.5 | 0.5 | 0.5 | 0.5 | 0.5 | 0.5 | 0.5 |
| Rimar | wt. % | 0.1 | 0.1 | 0.1 | 0.1 | 0.1 | 0.1 | 0.1 | 0.1 | 0.1 | 0.1 |
| MBS-1 | wt. % | | 6 | | | | | | | | |
| MBS-2 | wt. % | | | 6 | | | | | | | |
| MBS-3 | wt. % | | | | 6 | | | | | | |
| MBS-4 | wt. % | | | | | 6 | | | | | |
| MR03 | wt. % | | | | | | 6 | | | | |
| MR01 | wt. % | | | | | | | 6 | | | |
| S2030 | wt. % | | | | | | | | 6 | | |
| S2130 | wt. % | | | | | | | | | 6 | |
| SX005 | wt. % | | | | | | | | | | 6 |
| HDT | | 124 | 121 | 121 | 121 | 120 | 121 | 121 | 120 | 121 | 12 |
| NI 23° C. | KJ/m² | 75 | 61 | 73 | 71 | 70 | 73 | 76 | 68 | 53 | 74 |
| NI −30° C. | KJ/m² | 10.2 | 50 | 62 | 60 | 58 | 60 | 62 | 58 | 40 | 60 |
| NI −40° C. | KJ/m² | 7.8 | 38 | 59 | 56 | 55 | 59 | 61 | 56 | 38 | 51 |
| NI −50° | KJ/m² | 5.2 | 15 | 19 | 17 | 18 | 55 | 56 | 46 | 33 | 35 |
| UL 94 | | V0 | No | No | No | No | V0 | V0 | No | No | V0 |
| @ 1.0 mm | | | | | | | | | | | |
| Vx | | | | | | | | | | | |
| UL 94 | | V0 | No | No | No | No | V0 | V0 | No | No | V0 |
| @ 1.2 mm | | | | | | | | | | | |
| Vx | | | | | | | | | | | |
| MVR | cm³/10 | 14.5 | 9.7 | 8.9 | 9.6 | 9.1 | 10.1 | 9.5 | 10 | 10.4 | 9.7 |
| | min | | | | | | | | | | |

From this table it may be concluded that silicone based impact modifiers provide both a good flame retardancy rating as well as good low temperature impact properties. The composition of examples CE6 and CE7, while containing silicone-based impact modifiers, did not meet a V0 flame retardancy rating. The present inventors believe that for these specific compositions the amount of silicone in the impact modifier was too low.

Table 3 below shows a further series of experiments.

TABLE 3

| | | CE1 | CE8 | E3 | E4 | E5 |
|---|---|---|---|---|---|---|
| additives | wt. % | 0.62 | 0.62 | 0.62 | 0.62 | 0.62 |
| PC-1 | wt. % | 68.78 | 66.78 | 64.78 | 62.78 | 60.78 |
| PC-2 | wt. % | 30 | 30 | 30 | 30 | 30 |
| TSAN | wt. % | 0.5 | 0.5 | 0.5 | 0.5 | 0.5 |
| Rimar | wt. % | 0.1 | 0.1 | 0.1 | 0.1 | 0.1 |
| MR03 | wt. % | | 2 | 4 | 6 | 8 |
| HDT | oC | 124 | 123 | 122 | 121 | 119 |
| NI 23° C. | KJ/m² | 75 | 77 | 78 | 73 | 71 |
| NI −30° C. | KJ/m² | 10.2 | 41 | 56 | 60 | 66 |
| NI −40° C. | KJ/m² | 7.8 | 32 | 56 | 59 | 64 |
| NI −50° | KJ/m² | 5.2 | 12 | 50 | 55 | 57 |
| UL 94 @ | | V0 | V0 | V0 | V0 | V0 |
| 1.0 mm Vx | | | | | | |
| UL 94 @ | | V0 | V0 | V0 | V0 | V0 |
| 1.2 mm Vx | | | | | | |
| MVR | cm³/10 min | 14.5 | 12.3 | 10.7 | 10.1 | 8.6 |

From this table it may be concluded that silicone based impact modifiers provide both a good flame retardancy rating as well as good low temperature impact properties. Furthermore it can be observed that a minimum amount of silicone based modifier is required in order to obtain sufficient low temperature impact properties. Finally, it is observed that upon higher amounts of impact modifier the melt flow rate of the composition decreases.

Table 4 below shows a further series of experiments.

TABLE 4

| | | CE9 | E6 | E7 | E8 | E9 | E10 | E11 | E12 | E13 |
|---|---|---|---|---|---|---|---|---|---|---|
| additives | wt. % | 0.62 | 0.62 | 0.62 | 0.62 | 0.62 | 0.62 | 0.62 | 0.62 | 0.62 |
| PC-1 | wt. % | 64.88 | 64.68 | 64.73 | 64.705 | 64.73 | 64.83 | 63.88 | | |
| PC-2 | wt. % | 30 | 30 | 30 | 30 | 30 | 30 | 30 | 30 | |
| PC-3 | wt. % | | | | | | | | | 30 |
| PC-4 | wt. % | | | | | | | | 64.73 | 64.73 |
| TSAN | wt. % | 0.5 | 0.5 | 0.5 | 0.5 | 0.5 | 0.5 | 0.5 | 0.5 | 0.5 |
| Rimar | wt. % | | | | | 0.05 | 0.05 | 1 | 0.1 | 0.1 |
| KSS | wt. % | | 0.2 | | 0.1 | 0.1 | | | | |
| NATS | wt. % | | | 0.15 | 0.075 | | | | | |
| MR03 | wt. % | 4 | 4 | 4 | 4 | 4 | 4 | 4 | 4 | 4 |
| HDT | oC | 122 | 122 | 122 | 122 | 122 | 122 | 122 | 122 | 122 |
| NI 23° C. | KJ/m² | 77 | 72 | 74 | 76 | 77 | 79 | 74 | 79 | 81 |
| NI −30° C. | KJ/m² | 62 | 60 | 59 | 61 | 60 | 61 | 58 | 66 | 64 |
| NI −40° C. | KJ/m² | 58 | 55 | 57 | 56 | 53 | 59 | 53 | 60 | 62 |
| NI −50° | KJ/m² | 51 | 52 | 53 | 55 | 50 | 50 | 47 | 53 | 55 |
| UL 94 @ 1.0 mm | | No | V0 | V0 | V0 | V0 | V0 | V0 | V0 | V0 |
| Vx | | | | | | | | | | |
| UL 94 @ 1.2 mm | | No | V0 | V0 | V0 | V0 | V0 | V0 | V0 | V0 |
| Vx | | | | | | | | | | |
| UL 94 | | No | V0 | V0 | V0 | V0 | V0 | V0 | V0 | V0 |
| @ 1.5 mm Vx | | | | | | | | | | |
| MVR | cm³/10 | 10.5 | 11.6 | 11.3 | 10.7 | 11 | 10.9 | 10.5 | 11.2 | 10.4 |
| | min | | | | | | | | | |
| UL 94 | | 0 | 0.83 | 0.81 | 0.92 | 0.85 | 0.84 | 0.96 | 0.79 | 0.78 |
| @ 1.0 mm | | | | | | | | | | |
| V0 p(FTP) | | | | | | | | | | |

From Table 4 it may concluded that a flame retardant is required to obtain a V0 rating at 1.0 or 1.2 mm, while at the same time some flame retardants appear to be more suitable than others on the basis of the probability rating p(FTP). The table further shows that polycarbonate manufactured with an interfacial process performs similar or slightly better as compared to polycarbonate manufactured using a melt transesterification process. Or, put the other way around, melt polycarbonate is suitable as the source of polycarbonate in the claimed composition and may be preferred for logistical or commercial reasons.

1. A thermoplastic composition comprising, based on the total weight of the composition
(A) from 85-97 wt. % of aromatic polycarbonate
(B) from 3-12 wt. % of a core-shell impact modifier wherein the core is comprised of silicone and the shell comprised of acrylate,
(C) from 0.01-1.5 wt. % of a flame retardant
(D) from 0.01-2 wt. % of anti-drip agent,
wherein the sum of components (A)-(D) is at least 95 wt. % of the total weight of the composition, and
wherein the composition is selected to have
a melt volume rate of from 5-20 cm³/10 min. measured in accordance with ISO 1133 (300° C., 1.2 kg), and
a UL flame retardancy rating of V0 at 1.2 mm, and
a notched Izod Impact strength of at least 35 kJ/m² at a temperature of −50° C. measured in accordance with ISO 180/A on injection moulded test bars of 80×10×3 mm.

2. The composition of claim 1 wherein the composition does not comprise a polycarbonate-polysiloxane copolymer and/or a polysiloxane.

3. The composition of claim 1 wherein the polycarbonate (A) has a melt volume rate from 5-30 cm³/10 min. measured in accordance with ISO 1133 (300° C., 1.2 kg).

4. The composition of claim 1 wherein the polycarbonate (A) comprises at least 90 wt. % of bisphenol A polycarbonate homopolymer based on the total amount of polycarbonate (A).

5. The composition of claim 1 wherein the polycarbonate (A) comprises or consists of bisphenol A polycarbonate homopolymer obtained via a melt transesterification process.

6. The composition of claim 1 wherein the flame retardant is a chlorine and/or bromine free flame retardant.

7. The composition of claim 1 wherein the impact modifier comprises at least 50 wt. % of silicone based on the weight of the impact modifier.

8. The composition of claim 1 further selected to have a notched Izod Impact strength of at least 70 kJ/m² at a temperature of 23° C. measured in accordance with ISO 180/A on injection moulded test bars of 80×10×3 mm.

9. The composition of claim 1 wherein the notched Izod Impact strength is at least 40 kJ/m² at a temperature of −50° C. measured in accordance with ISO 180/A on injection moulded test bars of 80×10×3 mm.

10. The composition of claim 1 wherein the melt volume rate is from 8-20 cm³/10 min.

11. An article comprising or consisting of the composition of claim 1.

12. (canceled)

13. The composition of claim 6, wherein the flame retardant is selected from the group consisting of potassium perfluorobutane sulfonate, potassium perfluoroctane sulfonate, tetraethylammonium perfluorohexane sulfonate, potassium diphenylsulfone sulfonate, sodium benzene sulfonate, sodium toluene sulfonate and combinations of two or more of the foregoing.

14. The composition of claim 9, wherein the notched Izod Impact strength is at least 50 kJ/m² at a temperature of −50° C. measured in accordance with ISO 180/A on injection moulded test bars of 80×10×3 mm.

15. The composition of claim 10, wherein the melt volume rate is from 8-15 cm³/10 min.

16. The article of claim 11 being an injection molded article.
